(19) United States
(12) Patent Application Publication
(10) Pub. No.: US 2020/0234450 A1
(43) Pub. Date: Jul. 23, 2020

(54) REGION OF INTEREST HISTOGRAM PROCESSING FOR IMPROVED PICTURE ENHANCEMENT

(71) Applicant: QUALCOMM Incorporated, San Diego, CA (US)

(72) Inventors: Panikumar Gururaj Kallamballe, Bengaluru (IN); Bastin Joseph, Ernakulam (IN); Abhishek De, Bangalore (IN)

(21) Appl. No.: 16/250,886

(22) Filed: Jan. 17, 2019

(51) Int. Cl. G06T 7/194; G06T 5/40; G06T 7/143; G06T 7/136; G06T 7/44

(52) U.S. Cl. CPC G06T 7/194; G06T 5/40; G06T 7/44; G06T 7/136; G06T 7/143

(57) ABSTRACT

Methods, systems, and devices implementing region of interest (ROI) histograms for display processing (e.g., for display adjustment) are described. A display processing component may determine a histogram based on the ROI (e.g., based on gray levels corresponding to pixels within a frame or image aspect ratio) by removing or otherwise not considering background filler (e.g., background, such as solid black color, that may be added by a device to fill a panel area when an image or frame aspect ratio is not equivalent to the display panel aspect ratio). Source pipe programming (e.g., display information read from a display hardware pipeline and ROI information read from a video or image pipeline) may be used for improved histogram determination or histogram modification. A histogram for processing block operations may therefore be determined based on (e.g., or modified to reflect) the ROI corresponding to the image or frame to be displayed.

### BACKGROUND

The following relates generally to adjusting a display, and more specifically to region of interest histogram processing for improved picture enhancement.

A device may include a display panel in conjunction with backend device drivers for displaying an image or frame (e.g., pictures, videos, websites, applications, etc.). For example, backlight displays, such as liquid crystal displays (LCDs), may include a light source (e.g., a backlight) that illuminates optical elements of the respective displays. The optical elements of the display may receive input signals, for example, from a processor, video circuit, and/or a display driver. The input signals may define the images that are to be displayed by the display. Some displays, such as active matrix organic light emitting diode (AMOLED) displays, do not include a backlight. Instead, an AMOLED display includes individually addressable light emitting diodes (LEDs) that may be selectively driven to emit light.

As such, when outputting an image, a device may adjust display settings, such as brightness, pixel tone mapping setting, or backlighting (e.g., to enhance images, reduce eye fatigue, conserve battery power). For example, content adaptive backlight adjustments, adaptive brightness adjustments, pixel tone mapping adjustments, etc. may be applied to improve an output image (e.g., an image to be displayed). In some cases, a component may determine a histogram of display information, which may be read from a display hardware pipeline, and may use the information from the histogram to compute and adjust backlighting, brightness settings, pixel tone mapping settings, etc. In some cases (e.g., when an output image aspect ratio differs from a display panel aspect ratio, when a device displays an image that does not span the whole area of a display panel), however, such techniques may be deficient.

### SUMMARY

The described techniques relate to improved methods, systems, devices, and apparatuses that support region of interest (ROI) histogram processing for improved picture enhancement. For example, the described techniques may provide processing enhancements to adaptive brightness adjustment (ABA) schemes by selectively choosing regions represented in histograms used for some schemes, such ABA schemes. A display processing component, which may be or include a module in some cases, may determine a histogram based on the ROI (e.g., based on gray levels corresponding to pixels within the frame or image aspect ratio) by removing, ignoring, or otherwise not considering background filler (e.g., background, such as solid black color, that may be added by a device to fill a panel area when an image or frame aspect ratio is not equivalent to the panel aspect ratio). That is, source pipe programming (e.g., display information read from a display hardware pipeline and ROI information read from a video or image pipeline) may be used for improved histogram determination or histogram modification. A histogram for processing block operations may therefore be determined based on (e.g., or modified to reflect) the ROI corresponding to the image or frame to be displayed. The device (e.g., the display processing component) may use the information from the ROI histogram for improved computation and adjustment of, for example, backlighting, brightness settings, pixel tone mapping setting, etc.

In some cases, a number of pixels and corresponding pixel information (e.g., gray values) of the background filler may be determined, and a device may modify a histogram to remove at least some if not all contributions from the background filler. For example, a device may determine a histogram for the display based on display information read from a display hardware pipeline, and may remove contributions from the background filler at the gray level values of the histogram that correspond to the background gray levels. That is, additional background filler (e.g., background filling the panel outside of the image aspect ratio) may include one or more colors (e.g., or gray values). A device may compute a histogram of the number of pixels corresponding to at least some if not each gray level across the panel of the display (e.g., based on display information read from a display hardware pipeline), and may remove the background fill contributions to the histogram by subtracting the appropriate number of background pixels from the total number of pixels at each of the one or more gray values of the histogram that correspond to the background filler.

In other examples, a device may determine a region of interest (e.g., pixel rows and pixel columns of the display that correspond to the image or frame), and determine the histogram based on the ROI (e.g., without considering pixels and gray level values of the background filler). For example, a device may determine the histogram based on ROI information read from a video pipeline. That is, video enable signal information from a video pipeline may be used to compute the ROI histogram, such that pixels and gray levels of the ROI, obtained or identified from the video enable signal, may be considered when determining the histogram. As the video enable signal obtained from the source surface pipe programming may not include background filler information, the histogram may be determined based on the pixels within the image aspect ratio.

A method of adjusting a display is described. The method may include identifying an image based on source surface pipe programming, selecting a region of interest that is a subset of a display panel that includes the image based on the source surface pipe programming, determining a first histogram that is based on gray level values of the region of interest, and adjusting one or more gray levels of the region of interest based on the first histogram.

An apparatus for adjusting a display is described. The apparatus may include a processor, memory in electronic communication with the processor, and instructions stored in the memory. The instructions may be executable by the processor to cause the apparatus to identify an image based on source surface pipe programming, select a region of interest that is a subset of a display panel that includes the image based on the source surface pipe programming, determine a first histogram that is based on gray level values of the region of interest, and adjust one or more gray levels of the region of interest based on the first histogram.

Another apparatus for adjusting a display is described. The apparatus may include means for identifying an image based on source surface pipe programming, selecting a region of interest that is a subset of a display panel that includes the image based on the source surface pipe programming, determining a first histogram that is based on gray level values of the region of interest, and adjusting one or more gray levels of the region of interest based on the first histogram.

A non-transitory computer-readable medium storing code for adjusting a display is described. The code may include instructions executable by a processor to identify an image based on source surface pipe programming, select a region of interest that is a subset of a display panel that includes the image based on the source surface pipe programming, determine a first histogram that is based on gray level values of the region of interest, and adjust one or more gray levels of the region of interest based on the first histogram.

Some examples of the method, apparatuses, and non-transitory computer-readable medium described herein may further include operations, features, means, or instructions for identifying a number of pixels of a background region of the display and a gray level value that corresponds to the background region based on the source surface pipe programming, where the first histogram may be determined based on the number of pixels and the gray level value.

Some examples of the method, apparatuses, and non-transitory computer-readable medium described herein may further include operations, features, means, or instructions for identifying an enable signal from the source surface pipe programming, and identifying the region of interest based on the enable signal, where selecting the region of interest may be based on identifying the region of interest. In some examples of the method, apparatuses, and non-transitory computer-readable medium described herein, the first histogram may be determined based on the enable signal.

Some examples of the method, apparatuses, and non-transitory computer-readable medium described herein may further include operations, features, means, or instructions for determining a second histogram that may be based on gray level values of the display panel, and modifying the second histogram based on gray level values of a background region, where the first histogram may be determined based on modifying the second histogram.

Some examples of the method, apparatuses, and non-transitory computer-readable medium described herein may further include operations, features, means, or instructions for identifying a first number of pixels of the background region of the display, identifying one or more gray level values of the second histogram that correspond to the background region, identifying a second number of pixels corresponding to the one or more gray level values, and subtracting the first number of pixels from the second number of pixels for the gray level value of the second histogram, where the second histogram may be modified based on the subtracting.

Some examples of the method, apparatuses, and non-transitory computer-readable medium described herein may further include operations, features, means, or instructions for identifying a video enable signal from the source surface pipe programming, and identifying a number of rows of the image and a number of columns of the image based on identifying the video enable signal, where the region of interest may be selected based on the number of rows and the number of columns. In some examples of the method, apparatuses, and non-transitory computer-readable medium described herein, adjusting one or more gray levels of the region of interest may include operations, features, means, or instructions for performing an adaptive backlight adjustment process on the region of interest based on the video enable signal and the first histogram.

### BRIEF DESCRIPTION OF THE DRAWINGS

FIG. 1 illustrates an example of a system for adjusting a display that supports region of interest histogram processing for improved picture enhancement in accordance with aspects of the present disclosure.

FIG. 2 illustrates example histogram determination schemes that support region of interest histogram processing for improved picture enhancement in accordance with aspects of the present disclosure.

FIG. 3 illustrates an example of device processing that supports region of interest histogram processing for improved picture enhancement in accordance with aspects of the present disclosure.

FIG. 4 shows a block diagram of a device that supports region of interest histogram processing for improved picture enhancement in accordance with aspects of the present disclosure.

FIG. 5 shows a diagram of a system including a device that supports region of interest histogram processing for improved picture enhancement in accordance with aspects of the present disclosure.

FIG. 6 shows a flowchart illustrating methods that support region of interest histogram processing for improved picture enhancement in accordance with aspects of the present disclosure.

### DETAILED DESCRIPTION

A device, when displaying an image or frame, may adjust display settings (e.g., brightness settings, pixel tone mapping settings, backlighting) for image enhancement, visibility enhancement, battery conservation, etc. For example, a content adaptive backlight adjustment, an adaptive brightness adjustment (ABA), or a pixel tone mapping operation or process may be applied to image data to improve a displayed image. In some cases, a display processing component, which may be or include a module in some examples, may use a histogram, which may be read from a display hardware pipeline, to compute a target display setting (e.g., backlighting, brightness settings, pixel tone mapping settings). Such display enhancements based on histograms determined from pixels and gray levels of the entire display panel (e.g., histograms determined from a display hardware pipeline), however, may be deficient.

For example, in cases where an image or frame has an image aspect ratio dissimilar to the display panel aspect ratio (e.g., when a device displays an image that does not span the whole area of a display panel), additional background used to fill in the remaining display panel area may adversely affect such display visibility enhancements. Background filler (e.g., black pixels or other fill pixels surrounding the image aspect ratio to fill the display area) may be considered in histogram determination, although this filler may not be part of the image intended for ABA processing and may thus adversely affect the ABA processing of the ROI. Other techniques may be especially deficient if the background is a solid color (such as black) which may result in a large intensity peak in the histogram (e.g., at a gray level corresponding to the background filler), which may adversely alter determined display adjustments. In general, backlight adjustments, ABA schemes, pixel tone mapping adjustments, etc. (e.g., target display setting determinations) based on histograms that include information (e.g., pixel and gray level information) outside of a region of interest (ROI) may be improved.

The described techniques may provide for improved processing (e.g., backlight adjustments, ABA schemes, pixel tone mapping adjustments) via ROI histogram determination. ROI histograms may be determined by selectively choosing regions to be represented in histograms, or by removing background filler information from histograms determined from the entire display panel. That is, a display processing component may determine a histogram based on the ROI (e.g., based on gray levels corresponding to pixels within the frame or image aspect ratio of interest) by removing or otherwise not considering background filler. As such, background, such as solid black or white color, that may be added by a device (e.g., to fill a panel area when an image or frame aspect ratio is not equivalent to the panel aspect ratio) may not adversely affect target setting adjustments intended to enhance the ROI or such effects may be minimized.

Source pipe programming (e.g., display information read from a display hardware pipeline and ROI information read from a video or image pipeline) may be used for improved histogram determination or histogram modification. A histogram for processing block operations (e.g., post-processing block operations) may therefore be determined or modified based on (e.g., or modified to reflect) the ROI corresponding to the image or frame to be displayed. For example, a device may determine an ROI based histogram (e.g., by determining a histogram of ROI pixel information read from a video or image pipeline), or a device may determine a display panel based histogram (e.g., by determining a histogram of display panel pixel information read from a layer mixer or display hardware pipeline) and modify the display panel based histogram to remove background pixel contributions. In either case, the device (e.g., the display processing component) may then use the histogram of ROI pixel information for improved computation and adjustment of, for example, backlighting, brightness settings, pixel tone mapping setting, etc.

In some cases, a number of pixels and corresponding pixel information (e.g., gray values) of the background filler may be determined, and a device may modify a histogram to remove the contributions from the background filler or other information. For example, a device may determine a histogram for the display based on display information read from a display hardware pipeline, and may remove contributions from the background filler at the gray level values of the histogram that correspond to the background gray levels. That is, additional background filler (e.g., background filling the panel outside of the image aspect ratio) or other information may include one or more colors (e.g., or gray values). A device may compute a histogram of the number of pixels corresponding to each gray level across the panel of the display (e.g., based on display information read from a display hardware pipeline), and may remove the background filler contributions to the histogram by subtracting the appropriate number of background pixels from the total number of pixels at each of the one or more gray values of the histogram that correspond to the background filler.

In other examples, a device may determine a region of interest (e.g., pixel rows and pixel columns of the display that correspond to the image or frame), and determine the histogram based on the ROI (e.g., without considering pixels and gray level values of the background filler). For example, a device may determine the histogram based on ROI information read from a video pipeline. That is, video enable signal information from a video pipeline may be used to compute the ROI histogram, such that pixels and gray levels of the ROI, obtained or identified from the video enable signal, may be considered when determining the histogram. As the video enable signal obtained from the source surface pipe programming may not include the background filler information, the histogram may be determined based on the pixels within the image aspect ratio.

According to additional aspects of the described techniques, the enable signal used to determine the ROI (e.g., the enable signal used to determine the ROI histogram in the second example above) may further be used to control ROI enhancement. For example, the video enable signal may further be used to select only the ROI for content adaptive backlight adjustments, ABA, or a pixel tone mapping adjustments. That is, other techniques for display adjustment may further lack a means for controlling regions of the display to be adjusted. In some cases, other techniques may adjust or enhance pixels outside of the ROI (e.g., background filler that does not need to be adjusted). The techniques described herein may further provide for ROI display enhancement (e.g., ROI display adjustment processing) based on source surface pipe programming.

Aspects of the disclosure are initially described in the context of a display adjustment system. Example histogram determination and device processing in accordance with discussed adaptive brightness techniques are then described. Aspects of the disclosure are further illustrated by and described with reference to apparatus diagrams, system diagrams, and flowcharts that relate to region of interest histogram processing for improved picture enhancement.

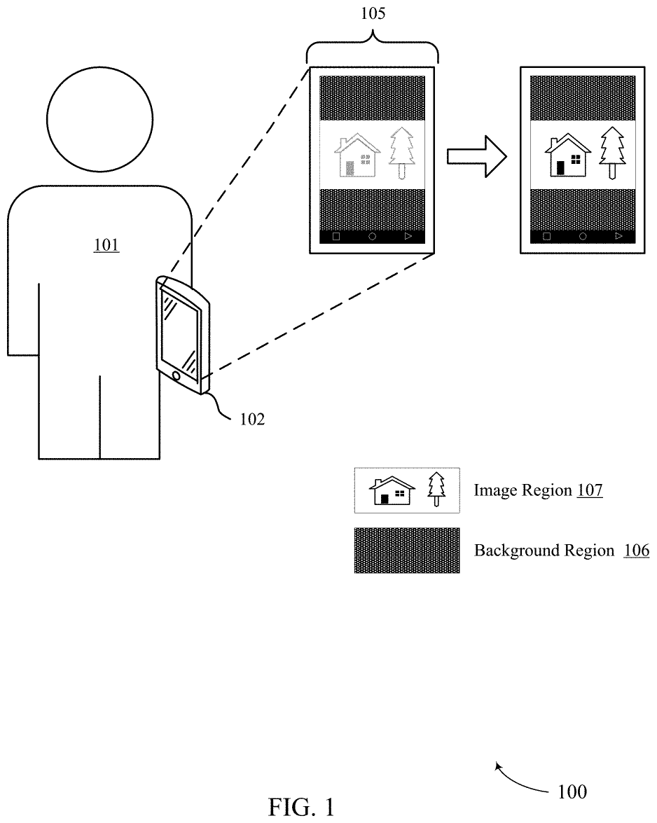

FIG. 1 illustrates an example of a system 100 that supports region of interest histogram processing for improved picture enhancement in accordance with aspects of the present disclosure. System 100 may include a user 101, and a device 102 that includes a display panel 105 (e.g. a screen, a liquid crystal display (LCD) panel, an organic light emitting diode (OLED) display panel, an active matrix organic light emitting diode (AMOLED) display panel, etc.). In some cases, a display panel 105 may include a background region 106 and an image region 107 (e.g., a ROI). In other cases, the image region 107 may span the entire area of the display panel 105. That is, in cases where the image region 107 is associated with a different aspect ratio than the display panel 105 aspect ratio (e.g., when an image or frame has an image aspect ratio dissimilar to the display panel aspect ratio), background region 106 (e.g., background filler) may be added to fill the remaining area of the display panel 105. As such, in cases where the image aspect ratio is the same as the display panel 105 aspect ratio, there may be no background region 106.

In some cases, it may be desirable to control the display panel 105 drivers in order to adjust the display panel 105 of a device 102 (e.g., to enhance a displayed image). As discussed above, such display processing techniques may determine a histogram of display information, which may be read from a display hardware pipeline, and may use the information from the histogram to compute and adjust backlighting, brightness settings, pixel tone mapping settings, etc. For example, the brightness of display panel 105 may be controlled by backend hardware and software using ABA techniques to display an image an image with a desired brightness (e.g., considering image quality, image readability, power usage, etc.), based on determined histogram information. In cases where an ABA flow uses a histogram computed for the entire display panel 105 (e.g., portrait or landscape oriented), based on the amount of background pixels which are not a part of the image region 107, the processed image may result in display adjustments that are not as expected, which may result in poor enhancements for sunlight readability (e.g., as background pixel information used for display adjustment may adversely affect how the image region 107 is ultimately displayed).

For example, a device 102 displaying an image region 107 (e.g., performing video playback, performing a camera preview, displaying an image) may send the image or frame to be displayed to one or more components, subcomponents, modules, or submodules of an image processing pipeline. Components, subcomponents, modules, or submodules of the image processing pipeline may be referred to as modules, engines, managers, systems, or subsystems. Such components or modules may be used by a device 102 to compose an image or frame for display, send image data to display hardware modules or systems, obtain histogram data representing current display settings (e.g., backlighting, pixel tone mapping settings, or brightness information), provide the histogram data to a display processing component, adjust backlighting, brightness settings, pixel tone mapping settings, etc., and ultimately display the image or frame.

System 100 may support techniques for improved processing (e.g., backlight adjustments, ABA schemes, pixel tone mapping adjustments) via ROI histogram determination. ROI histograms may be determined by selectively choosing regions to be represented in histograms (e.g., image region 107), or by removing background filler information (e.g., background region 106 information) from histograms determined from the entire display panel 105. That is, a display processing component may determine a histogram based on the ROI (e.g., based on gray levels corresponding to pixels within the image region 107) by removing or otherwise not considering background filler (e.g., gray levels corresponding to pixels within the background region 106). As such, background regions 106, such as solid black color, that may be added by a device 102 (e.g., to fill a display panel 105 area when an image region 107 aspect ratio is not equivalent to the display panel 105 aspect ratio) may not adversely affect display adjustments intended to enhance the ROI (e.g., the image region 107).

System 100 may further support ROI display adjustments (e.g., application of display adjustments to the image region 107). For example, an enable signal used to determine the image region 107 (e.g., the enable signal used to determine the ROI histogram obtained from source surface pipe programming) may further be used to control image region 107 enhancement. For example, the video enable signal may further be used to select only the ROI (e.g., image region 107) for content adaptive backlight adjustments, ABA, or a pixel tone mapping adjustments. As such, in some cases, a device 102 may not adjust or enhance pixels outside of the ROI (e.g., pixels of background region 106 that do not need to be adjusted).

As used herein, a device 102 may refer to any device with a display panel, display screen, backlight, etc. In some cases, device 102 may refer to a camera, a mobile device, a wireless device, a remote device, a handheld device, a subscriber device, a personal electronic device such as a cellular phone, a personal digital assistant (PDA), a tablet computer, a laptop computer, a personal computer, or some other suitable terminology.

A display panel 105 may be implemented as part of a device 102 and may include various driving or supporting systems. For example, in some cases, a display panel 105 may include or refer to backlight displays, such as LCDs, that include a light source (e.g., a backlight) that illuminates optical elements of the respective displays. The optical elements of the display may receive input signals, for example, from a processor, video circuit, and/or a display driver. The input signals define the images that are to be displayed by the display. The backlight level may be adjusted to reduce power consumption caused by the backlight display. In some cases, a display panel 105 may include or refer to OLED displays or AMOLED displays that include individually addressable light emitting diodes (LEDs) that can be selectively driven to emit light. In an AMOLED display, overall brightness of the LEDs may be adjusted to reduce power consumption by the display. In general, a display panel 105 may refer to any display, monitor, screen, or other suitable hardware for displaying an image.

One or more driver circuits for image processing or image processing pipeline components (e.g., of device 102) may process image information according to techniques described herein (e.g., to adjust display settings of the display panel 105 for image region 107). In some cases, the described techniques may be performed by a general processor or general central processing unit (CPU), a dedicated piece of hardware, a system on chip (SoC), etc. Further, the device 102 may include electrical connections associated with the display panel 105 and the one or more drivers (e.g., the processor).

In some cases, background region 106 (e.g., background filler) may be set as a default setting in a device configuration. In some cases a device 102 may display a single color (e.g., black, gray, white, etc.) as the background region 106. In some cases a device may display a multi-color image as the background region 106 (e.g. an advertisement, a pattern, another image, etc.). In either case, the background region 106 may refer to display information (e.g., background pixels and background pixel information, such as background gray levels) used to fill the display panel 105, which may otherwise not be a part of the image region 107.

Techniques described with reference to aspects of system 100 are done so for exemplary purposes only, and are not intended to be limiting in terms of the applicability of the described techniques. That is, the techniques described may be implemented in, or applicable to, other processing blocks that utilize display histogram information, without departing from the scope of the present disclosure.

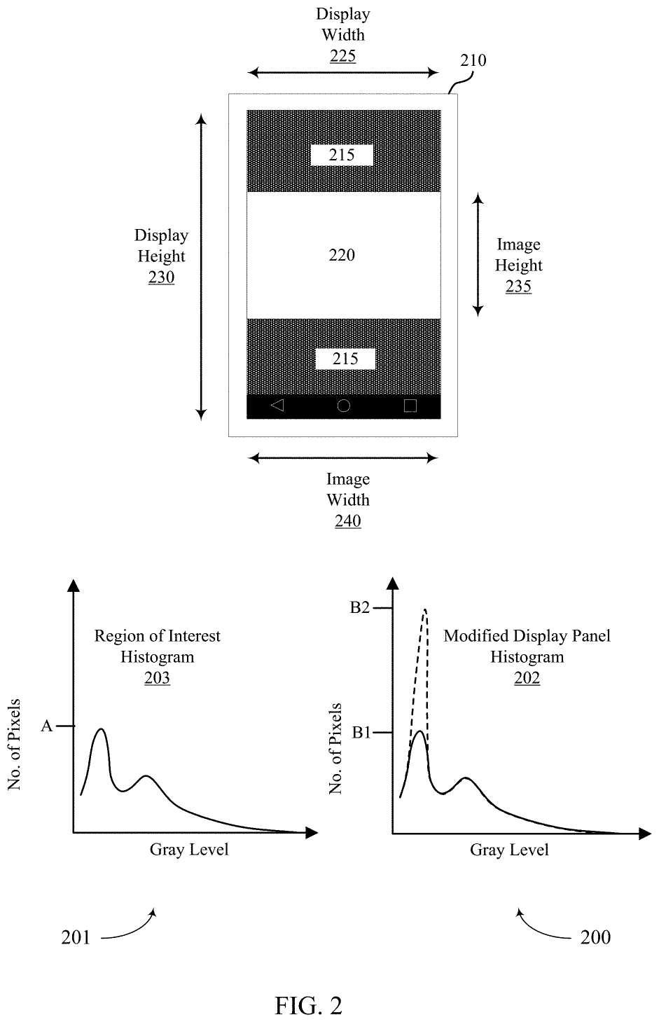

FIG. 2 illustrates an example histogram determination scheme 200 and an example histogram determination scheme 201 that each support region of interest histogram processing for improved picture enhancement in accordance with aspects of the present disclosure. In some examples, histogram determination scheme 200 and histogram determination scheme 201 may implement aspects of system 100. A device may include a display panel 210. A display panel 210 may be configured to display a ROI 220 (e.g., an image region 107) that has an image aspect ratio that does not match the display panel aspect ratio. As such, display panel 210 may be further configured to display background area(s) 215 (e.g., background regions 106) in addition to the ROI 220 to fill the aspect ratio of the display panel 210. In some cases, a ROI 220 may have an image width 240 and an image height 235. In some cases, image width 240 may be the same as a display width 225. In some cases, an image height 235 may span a portion of a display height 230. In such cases, background areas 215 may fill a remaining areas between an image height 235 and a display height 230.

In example histogram determination scheme 200, background areas 215 may be a single color and histogram may be determined based on pixel information of the entire display panel 210 (e.g., including pixel information associated with background areas 215 and pixel information associated with the ROI 220). A device may identify the pixel information or pixel data that originated from the background areas 215, and may remove such pixel information or pixel data to determine the modified display panel histogram 202. For example, a device may identify gray levels associated with background area(s) 215 by identifying a difference (e.g., an increase or a spike) in pixel count for one or more gray levels. The device may then determine a number of pixels associated with background region (e.g., by subtracting the pixels of the ROI 220, identified via a video enable signal, from the pixels of the full display panel 210, identified via a display enable signal), and may make an adjustment (e.g., may subtract the number of background pixels from the identified gray levels) to determine the modified display panel histogram 202.

In the example of FIG. 2, the spike in the number of pixels from values B1 to B2 may indicate the gray levels that correspond to background area(s) 215, and the difference between B2 and B1 may indicate the number of pixels in background area(s) 215 that do not correspond to the ROI 220 (e.g., B2−#ofBackgroundPixels=B1). The pixel data that corresponds to the background areas 215 may thus be subtracted from the histogram to give a ROI histogram 203 (e.g., B1 may thus represent the number of ROI 220 pixels associated with the gray level that is otherwise included in background area(s) 215).

In some cases, device programming (e.g., software) may identify background area(s) 215 fill color values (e.g., gray levels associated with background pixels) from source surface pipe programming registers. The device may thus modify a histogram determined from the display panel 210 (e.g., the device may determine the modified display panel histogram 202) by performing the following calculations:

Total No. of Pixels (TOTₚᵢₓ)=(H*W)

Total No. of Pixels in the ROI (ROIₚᵢₓ)=(ROI_H*ROI_W)

Total No. of Background Pixels (Bₚᵢₓ)=(TOTₚᵢₓ−ROIₚᵢₓ)

where, H=display height 230, W=display width 225, ROI_H=image height 235, and ROI_W=image width 240. The histogram may then be updated at the background fill color (e.g., at the gray levels of the histogram corresponding to the background filler gray levels, per the following equation.

New Value=(Current value from the original image−BGₚᵢₓ)

where Current value from the original image=B2, and thus New Value=B1 in the illustration of FIG. 2.

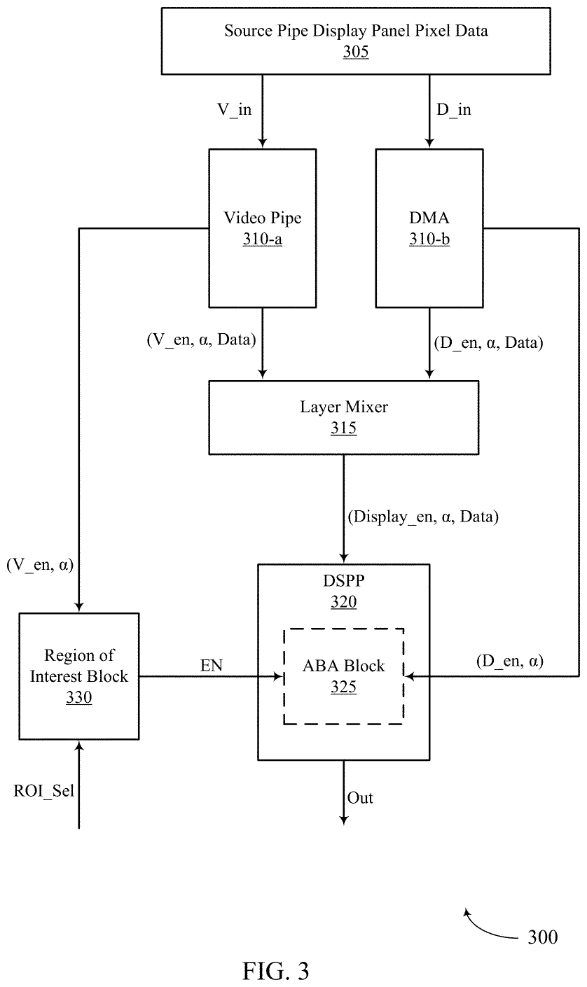

In example histogram determination scheme 201, background areas 215 may be any number of colors, or in some cases may be another image or advertisement, and the histogram may be determined based on pixel information of the ROI 220 (e.g., including pixel information associated with the ROI 220, however excluding pixel information associated with background areas 215). As discussed herein, histogram determination scheme 201 may use source surface pipe programming (e.g., a video enable signal) to determine a ROI histogram 203 (e.g., as described in more detail below with reference to FIG. 3).

FIG. 3 illustrates an image processing pipeline 300 that supports region of interest histogram processing for improved picture enhancement in accordance with aspects of the present disclosure. In some examples, image processing pipeline 300 may implement aspects of system 100. The image processing pipeline 300 may include one or more components, modules, engines, managers, systems, or subsystems. Modules of the image processing pipeline may be implemented in hardware, software executed by a processor, firmware, or any combination thereof. In some examples, modules of the image processing pipeline 300 may be implemented in specialized hardware for the purpose of executing processes of the image processing pipeline, or may be implemented in generic hardware in combination with specialized software. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Image processing pipeline 300 may be implemented by a device and may include multiple operations (e.g., described as relating to blocks that may be or include components) that can be performed alone or in various combinations. In some cases, image processing pipeline 300 may illustrate one or more aspects of source surface pipe programming. In generally, source surface pipe programming may refer to a configuration setup for each display pipe (e.g., video pipe block 310-a and distributed memory access (DMA) block 310-b) which may include image resolutions, image depth, layer position, blending information, etc. For example, source pipe display panel pixel data 305 may be processed by a number of different source surface processing pipes. In the example of FIG. 3, source pipe display panel pixel data 305 may be processed along a video pipe block 310-a and a DMA block 310-b (e.g., a graphics pipe). Generally, an image processing pipeline 300 may include any number of programming pipes.

Image processing pipeline 300 may illustrate various components or modules (such as layer mixer 315, ROI block 330, destination surface processor pipes (DSPP) 320, etc.) that may exchange information, such as source surface pipe programming information, to perform the various techniques described herein. For example, a video pipe block 310-a may receive video pipe data input (V_in) and output an enable for the video pipe (V_en), an alpha blending parameter (a), and data. DMA block 310-b may receive graphics pipe data input (D_in) and output an enable for the graphics pipe (D_en), an alpha blending parameter (a), and data.

A layer mixer 315 may mix together information from the video pipe block 310-a and the DMA block 310-b (e.g., data) according to V_en and D_en, as well as a. The layer mixer 315 may output an enable for the display (Display_en), an alpha blending parameter (a), and data. For example, the layer mixer 315 may know how to order pixel information (e.g., from V_en and D_en information), and may output information (e.g., Display_en, a, Data) including such ordering to eventually be displayed. In cases where image processing pipeline 300 includes additional processing pipes, the layer mixer may mix all of such to output an ordered (e.g., mixed) Display_en, a, Data for the DSPP 320 to adjust and ultimately display.

That is, DSPP 320 may perform display adjustment techniques and output an image (e.g., output adjusted display information). For example, DSPP 320 may perform content adaptive backlight adjustments, ABA, pixel tone mapping adjustments, etc. to improve an output image (Out). That is, DSPP 320 may include submodules (e.g., ABA block 325) to adjust display settings such as brightness, pixel tone mapping settings, or backlighting when outputting an image to be displayed (Out). In some examples, DSPP 320 may refer to a display processing component (DSP).

In some examples, a device may generate a histogram comprising image data. For example, histogram data corresponding to an image or display panel may include brightness, saturation, backlighting, or other display setting data. Histogram data may be utilized by a device (e.g., by DSP or DSPP 320) to set or adjust display settings for displaying subsequent image frames.

In some cases, a display processing component (e.g., DSPP 320) may read histogram data from a display hardware pipeline while the composed output frame (Out) is rendered to the panel of the device for display. The display processing component (e.g., DSP or DSPP 320) or other hardware or software modules (e.g., ABA block 325) may use the information from the histogram to compute and adjust display settings. Such computed settings or adjustments may be applied to achieve power savings in the device, and may also improve the output image (e.g., may be used to set contrast and enhancement features of the output image).

As discussed above, in cases where a histogram is determined based on the entire display panel (e.g., based on Display_en, and data from the layer mixer 315), scenarios may arise where background filler adversely affects histogram information, and thus display adjustments based on the histogram information. The described techniques may identify a region of interest based on source surface pipe programming (e.g., based on V_en, D_en, and/or Display_en), such that such histograms may be modified to remove background pixel information, or such that histograms may be determined based on ROI pixel information alone.

For example, a device may identify a programming pipe that processes or includes information for the surface of the image (e.g., video pipe block 310-a), and may determine a ROI (e.g., at ROI block 330) via a video enable signal 335 of the video pipe block 310-a. The device may identify a number of pixel rows of the ROI or image region, a number of pixel columns of the ROI or image region, pixel information (e.g., gray level information, brightness information, saturation information, backlighting information, or other display setting data) of the pixels within the ROI or image region, etc.

For example, the ROI (e.g., the image or surface of the image) may be derived from one pipe (e.g., video pipe block 310-a) and the background (e.g., background filler outside of the ROI) may be derived from another pipe (e.g., DMA block 310-b). In some examples, for every pipe, starting lines and ending lines (e.g., pixel rows and pixel columns) may be known based on horizontal resolution enable and vertical resolution enable.

That is, ROI block 330 may identify pixel rows and pixel columns of the region of interest based on V_en information, where V_en (e.g., video (VIG) enable) may be computed from horizontal and vertical data enable signals from each of the source pipe programming. In some examples, the ROI block 330 may then use a signal, such as an enable signal (EN), to enable the histogram block (e.g., in ABA block 325) to get the respective data for display adjustment processing (e.g., EN may be generated as a function of a, V_en, and D_en).

In examples where a histogram of the display panel is modified to remove background pixel information (e.g., modified display panel histogram 202, as described above with reference to FIG. 2), histogram data may be computed based on a display enable signal (e.g., Display_en) generated from the layer mixer composition with a blending values, horizontal enables, and vertical enables of the display panel. The device may then identify and remove background contributions to the histogram (e.g., by identifying one or more background gray levels and a number of background pixels, from DMA block 310-b, and subtracting background contributions from the histogram). This way, the histogram may not be enabled for background (e.g., and thus enhancements or display adjustments may be determined only based on the ROI).

That is, a device may identify a first number of pixels of the background region of the display (e.g., from DMA block 310-b), identify one or more gray level values of a display panel based histogram that correspond to the background region, identify a number of pixels corresponding to the one or more gray level values, and/or subtract the number of pixels corresponding to the one or more gray level values from the one or more gray level values of the histogram. In other words, the device may determine a display panel based histogram that is based at least in part on gray level values of the display panel, and modify the display panel based histogram based on gray level values of a background region, where the ROI based histogram is determined based on modifying the display panel based histogram.

In examples where a histogram of the ROI is determined to ignore or not consider background pixel information (e.g., ROI histogram 203, as described above with reference to FIG. 2), histogram data may be computed based on EN signal generated from the ROI block 330 or from the video pipe block 310-a. This way, the histogram is not enabled for background, as the histogram may be determined based on the horizontal enables, and vertical enables of the ROI (e.g., and thus enhancements or display adjustments may be determined only based on the ROI).

That is, a device may identify an enable signal (e.g., EN) from the source surface pipe programming (e.g., from video pipe block 310-a), and may identify the ROI based on the enable signal. The device may then determine a histogram based on the identified ROI (e.g., the device may determine a histogram of the gray levels of pixels identified by pixel rows of the image and pixel columns of the image indicated by the video enable signal).

For example, a content adaptive backlight and brightness adjustment operation or a pixel tone mapping operation or adjustment may be applied to image data and current display settings of a captured image to improve an output image. For example, a DSP may program a lookup table (LUT) (e.g., brightness settings) to mobile display hardware (for histogram processing) and may program backlight values to a backlight driver. In such examples, backlight values from backlight driver and brightness settings or pixel tone mapping settings in the form of a LUT from mobile display hardware may be applied to the display (e.g., to an LCD panel). As such, content adaptive backlight and brightness adjustment operation or a pixel tone mapping operation may generally refer to an operation where the device processes the ROI histogram using a LUT, and adjusts or sets backlight values, pixel mappings, etc., in accordance with the LUT (e.g., the device adjusts backlighting, pixel mapping, etc., based on the histogram and target settings identified via the LUT).

In some cases, the ROI block 330 may determine EN based on a select signal (ROI_Sel) for enabling the ROI based histogram determination (e.g., where the device determines the histogram based on the ROI, using the EN). For example, in cases where the ROI_Sel is not signaled, the ROI based histogram determination may be disabled (e.g., although the device may still modify a display panel histogram by subtracting the background pixel information, via the D_en). In other words, the enable signal may be generated as a function of (a, V_en and D_en) when ROI_Sel is selected to define the region of interest, and the DSPP 320 (e.g., the ABA block 325) may determine a histogram for display adjustment based on the EN. In some examples, the EN may thus trigger ROI based histogram determination and ROI processing (e.g., processing of the ROI, excluding background pixel processing).

In cases when the background pixels are generated from a graphical image (e.g., more than a single color) a ROI histogram may be processed based on the layer selection control signal from the source pipe display panel pixel data 305. In this case, a hardware that would enable ABA block 325 and select the ROI for histogram processing would be required. Histogram data may be computed based on the data generated by the layer mixer 315 and passed on to the DSPP 320. Data passed on to the DSPP 320 may include blending values, horizontal enable signals and vertical enable signals. Video and Display enable signals may be used in the ABA block 325 to get the region of interest for the processing. The video and display enable signals may be computed from the horizontal and vertical enable signals from the source pipe display panel pixel data 305.

The video and display enable signals may be used to control enhancement of a region of interest and may select only a region of interest to be processed in ABA block 325. In this case the background region may remain unaltered since the background region was bypassed in the ABA block 325.

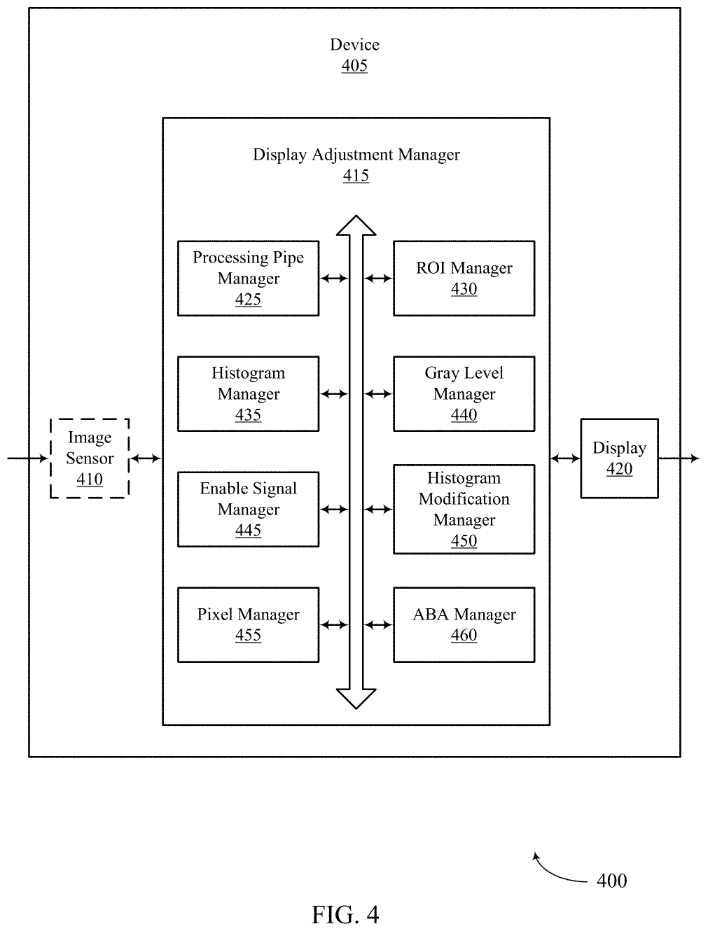

FIG. 4 shows a block diagram 400 of a device 405 that supports region of interest histogram processing for improved picture enhancement in accordance with aspects of the present disclosure. The device 405 may be an example of aspects of a device as described herein (e.g., a device 102). The device 405 may include a display adjustment manager 415 and a display 420. In some cases, the device 405 may include an image sensor 410. The device 405 may also include a processor. Each of these components may be in communication with one another (e.g., via one or more buses).

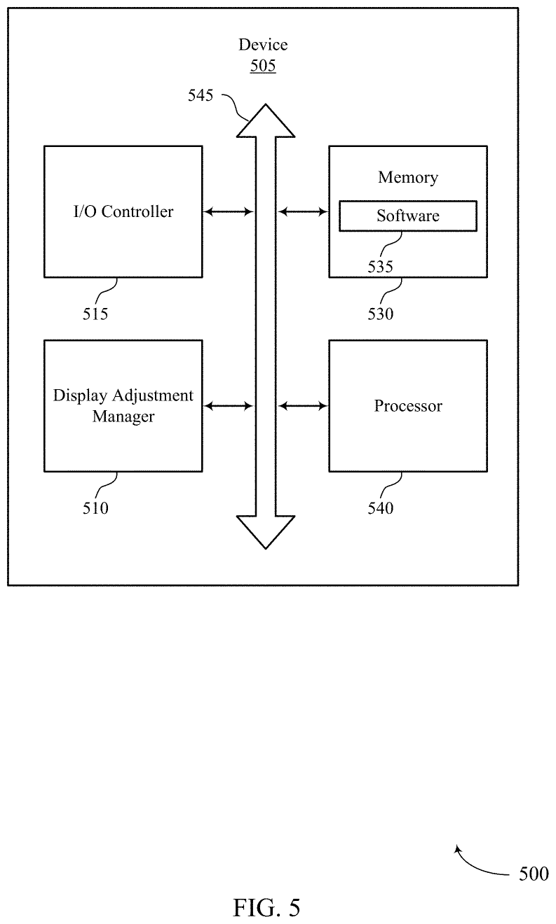

The image sensor 410 (e.g., a camera) may receive information (e.g., light), which may be passed on to other components of the device 405. In some cases, the image sensor 410 may be an example of aspects of the I/O controller 515 described with reference to FIG. 5. For example, the image sensor 410 may utilize one or more photosensitive elements that have a sensitivity to a spectrum of electromagnetic radiation to receive information (e.g., to receive a pixel intensity values, red green blue (RGB) values of a pixel, etc.) depending on the configuration of the image sensor 410. Information may be passed on to other components of the device 405. For example, in some cases, image sensor 410 may capture an image that may be passed to the display adjustment manager 415 (e.g., for display adjustments), and ultimately display via the display 420 (e.g., a device 405 may utilize an image sensor 410 when performing camera preview using the techniques described herein).

The display adjustment manager 415 may identify an image based on source surface pipe programming, select a region of interest that is a subset of a display panel that includes the image based on the source surface pipe programming, determine a first histogram that is based on gray level values of the region of interest, and adjust one or more gray levels of the region of interest based on the first histogram. The display adjustment manager 415 may be an example of aspects of the display adjustment manager 510 described herein.

The display adjustment manager 415, or its sub-components, may be implemented in hardware, code (e.g., software or firmware) executed by a processor, or any combination thereof. If implemented in code executed by a processor, the functions of the display adjustment manager 415, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The display adjustment manager 415, or its sub-components, may be physically located at various positions, including being distributed such that portions of functions are implemented at different physical locations by one or more physical components. In some examples, the display adjustment manager 415, or its sub-components, may be a separate and distinct component in accordance with various aspects of the present disclosure. In some examples, the display adjustment manager 415, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The display adjustment manager 415 may be an example of aspects of a display adjustment manager 510 described herein. In some cases, the display adjustment manager 415 may include a processing pipe manager 425, a ROI manager 430, a histogram manager 435, a gray level manager 440, an enable signal manager 445, a histogram modification manager 450, a pixel manager 455, and an ABA manager 460. Each of these components or modules may communicate, directly or indirectly, with one another (e.g., via one or more buses).

The processing pipe manager 425 may identify an image based on source surface pipe programming. In some examples, the processing pipe manager 425 may identify a video enable signal from the source surface pipe programming (e.g., and may identify the image based on the video enable signal).

The ROI manager 430 may select a region of interest that is a subset of a display panel that includes the image based on the source surface pipe programming. In some examples, the ROI manager 430 may identify the region of interest based on the enable signal, where selecting the region of interest is based on identifying the region of interest. In some examples, the ROI manager 430 may identify a number of rows of the image and a number of columns of the image based on identifying the video enable signal, where the region of interest is selected based on the number of rows and the number of columns. In some cases, the first histogram is determined based on the enable signal. The histogram manager 435 may determine a first histogram that is based on gray level values of the region of interest. The gray level manager 440 may adjust one or more gray levels of the region of interest based on the first histogram.

In some examples, the histogram manager 435 may determine a second histogram that is based on gray level values of the display panel. In some examples, the processing pipe manager 425 may identify a number of pixels of a background region of the display and a gray level value that corresponds to the background region based on the source surface pipe programming (e.g., where the first histogram may be determined based on the number of pixels and the gray level value). The pixel manager 455 may identify a first number of pixels of the background region of the display. In some examples, the pixel manager 455 may identify a second number of pixels corresponding to the one or more gray level values. In some examples, the gray level manager 440 may identify one or more gray level values of the second histogram that correspond to the background region. The histogram modification manager 450 may modify the second histogram based on gray level values of a background region, where the first histogram is determined based on modifying the second histogram. In some examples, the histogram modification manager 450 may subtract the first number of pixels from the second number of pixels for the gray level value of the second histogram, where the second histogram is modified based on the subtracting.

The enable signal manager 445 may identify an enable signal from the source surface pipe programming. The gray level manager 440 may adjust one or more gray levels of the region of interest based on the first histogram. The ABA manager 460 may perform an adaptive backlight adjustment process on the region of interest based on the video enable signal and the first histogram.

The display 420 may display (e.g., illuminate) according to signals or information generated by other components of the device 405. For example, the display 420 may receive display information (e.g., display adjustments, pixel mapping) from display adjustment manager 415 (e.g., from the ABA manager 460, the gray level manager), and may illuminate accordingly. The display 420 may represent a unit capable of displaying video, images, text or any other type of data for consumption by a viewer. Display 420 may include a LCD, a LED display, an organic LED (OLED) display, an AMOLED display, or the like. In some cases, display 420 and an I/O controller (e.g., I/O controller 515) may be or represent aspects of a same component (e.g., a touchscreen) of device 405.

FIG. 5 shows a diagram of a system 500 including a device 505 that supports region of interest histogram processing for improved picture enhancement in accordance with aspects of the present disclosure. The device 505 may be an example of or include the components of a device 102, device 405, or a device as described herein. The device 505 may include components for bi-directional voice and data communications including components for transmitting and receiving communications, including a display adjustment manager 510, an I/O controller 515, memory 530, and a processor 540. These components may be in electronic communication via one or more buses (e.g., bus 545).

The display adjustment manager 510 may identify an image based on source surface pipe programming, select a region of interest that is a subset of a display panel that includes the image based on the source surface pipe programming, determine a first histogram that is based on gray level values of the region of interest, and adjust one or more gray levels of the region of interest based on the first histogram.

The I/O controller 515 may manage input and output signals for the device 505. The I/O controller 515 may also manage peripherals not integrated into the device 505. In some cases, the I/O controller 515 may represent a physical connection or port to an external peripheral. In some cases, the I/O controller 515 may utilize an operating system such as iOS®, ANDROID®, MS-DOS®, MS-WINDOWS®, OS/2®, UNIX®, LINUX®, or another known operating system. In other cases, the I/O controller 515 may represent or interact with a modem, a keyboard, a mouse, a touchscreen, or a similar device. In some cases, the I/O controller 515 may be implemented as part of a processor. In some cases, a user may interact with the device 505 via the I/O controller 515 or via hardware components controlled by the I/O controller 515.

The memory 530 may include RAM and ROM. The memory 530 may store computer-readable, computer-executable code or software 535 including instructions that, when executed, cause the processor to perform various functions described herein. In some cases, the memory 530 may contain, among other things, a BIOS which may control basic hardware or software operation such as the interaction with peripheral components or devices.

The processor 540 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 540 may be configured to operate a memory array using a memory controller. In other cases, a memory controller may be integrated into the processor 540. The processor 540 may be configured to execute computer-readable instructions stored in a memory (e.g., the memory 530) to cause the device 505 to perform various functions (e.g., functions or tasks supporting region of interest histogram processing for improved picture enhancement).

The software 535 may include instructions to implement aspects of the present disclosure, including instructions to support adjusting a display. The software 535 may be stored in a non-transitory computer-readable medium such as system memory or other type of memory. In some cases, the software 535 may not be directly executable by the processor 540 but may cause a computer (e.g., when compiled and executed) to perform functions described herein.

In some cases, a processing component of a device (e.g., display adjustment manager 510 and/or processor 540) may include and apply one or more operations or calculations to generate display setting updates (e.g., brightness values, pixel tone mapping settings, and backlighting updates) for a current histogram based on the current histogram data. The display setting updates may be programmed for application at mobile display hardware, such as at a display 420, I/O controller 515, etc. (e.g., as well as at a backlight driver associated with the mobile display hardware). In some examples, a display processing component (e.g., display adjustment manager 510 and/or I/O controller 515) may program a LUT (e.g., brightness settings) for mobile display hardware (e.g., for histogram processing) may program backlight values to a backlight driver connected to the display hardware. In such examples, backlight values from a backlight driver and brightness settings or pixel tone mapping settings in the form of a LUT from mobile display hardware may be applied to the display (e.g., to display 420).

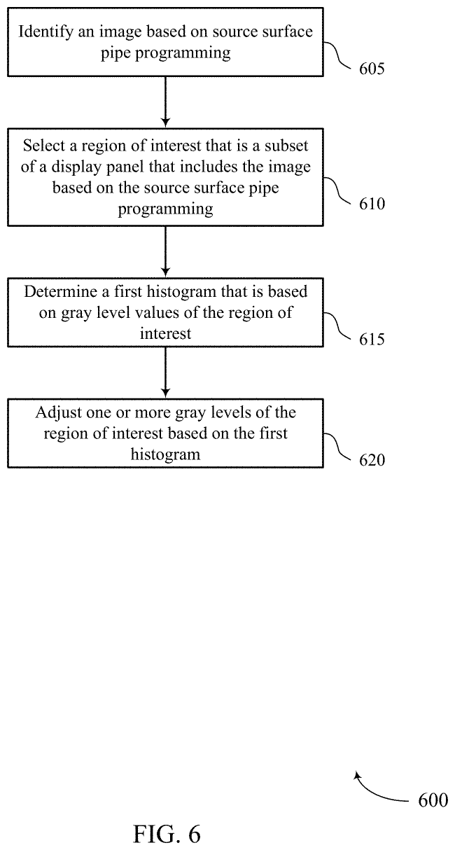

FIG. 6 shows a flowchart illustrating a method 600 that supports region of interest histogram processing for improved picture enhancement in accordance with aspects of the present disclosure. The operations of method 600 may be implemented by a device or its components as described herein. For example, the operations of method 600 may be performed by a display adjustment manager as described with reference to FIGS. 4 through 5. In some examples, a device may execute a set of instructions to control the functional elements of the device to perform the functions described below. Additionally or alternatively, a device may perform aspects of the functions described below using special-purpose hardware.

At 605, the device may identify an image based on source surface pipe programming. The operations of 605 may be performed according to the methods described herein. In some examples, aspects of the operations of 605 may be performed by a processing pipe manager as described with reference to FIGS. 4 through 5.

At 610, the device may select a region of interest that is a subset of a display panel that includes the image based on the source surface pipe programming. The operations of 610 may be performed according to the methods described herein. In some examples, aspects of the operations of 610 may be performed by a ROI manager as described with reference to FIGS. 4 through 5.

At 615, the device may determine a first histogram that is based on gray level values of the region of interest. The operations of 615 may be performed according to the methods described herein. In some examples, aspects of the operations of 615 may be performed by a histogram manager as described with reference to FIGS. 4 through 5.

At 620, the device may adjust one or more gray levels of the region of interest based on the first histogram. The operations of 620 may be performed according to the methods described herein. In some examples, aspects of the operations of 620 may be performed by a gray level manager as described with reference to FIGS. 4 through 5.

It should be noted that the methods described herein describe possible implementations, and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks, components, and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for adjusting a display at a device, comprising:
identifying an image based at least in part on source surface pipe programming;
selecting a region of interest that is a subset of a display panel that comprises the image based at least in part on the source surface pipe programming;
determining a first histogram that is based at least in part on gray level values of the region of interest; and
adjusting one or more gray levels of the region of interest based at least in part on the first histogram.

2. The method of claim 1, further comprising:
identifying a number of pixels of a background region of the display and a gray level value that corresponds to the background region based at least in part on the source surface pipe programming, wherein the first histogram is determined based at least in part on the number of pixels and the gray level value.

3. The method of claim 1, further comprising:
identifying an enable signal from the source surface pipe programming; and
identifying the region of interest based at least in part on the enable signal, wherein selecting the region of interest is based at least in part on identifying the region of interest.

4. The method of claim 3, wherein the first histogram is determined based at least in part on the enable signal.

5. The method of claim 1, further comprising:
determining a second histogram that is based at least in part on gray level values of the display panel; and
modifying the second histogram based at least in part on gray level values of a background region, wherein the first histogram is determined based at least in part on modifying the second histogram.

6. The method of claim 5, further comprising:
identifying a first number of pixels of the background region of the display;
identifying one or more gray level values of the second histogram that correspond to the background region;
identifying a second number of pixels corresponding to the one or more gray level values; and
subtracting the first number of pixels from the second number of pixels for the one or more gray level values of the second histogram, wherein the second histogram is modified based at least in part on the subtracting.

7. The method of claim 1, further comprising:
identifying a video enable signal from the source surface pipe programming; and
identifying a number of rows of the image and a number of columns of the image based at least in part on identifying the video enable signal, wherein the region of interest is selected based at least in part on the number of rows and the number of columns.

8. The method of claim 7, wherein adjusting the one or more gray levels of the region of interest comprises:
performing an adaptive backlight adjustment process on the region of interest based at least in part on the video enable signal and the first histogram.

9. An apparatus for adjusting a display at a device, comprising:
a processor, memory in electronic communication with the processor; and
instructions stored in the memory and executable by the processor to cause the apparatus to:
identify an image based at least in part on source surface pipe programming;
select a region of interest that is a subset of a display panel that comprises the image based at least in part on the source surface pipe programming;
determine a first histogram that is based at least in part on gray level values of the region of interest; and
adjust one or more gray levels of the region of interest based at least in part on the first histogram.

10. The apparatus of claim 9, wherein the instructions are further executable by the processor to cause the apparatus to:
identify a number of pixels of a background region of the display and a gray level value that corresponds to the background region based at least in part on the source surface pipe programming, wherein the first histogram is determined based at least in part on the number of pixels and the gray level value.

11. The apparatus of claim 9, wherein the instructions are further executable by the processor to cause the apparatus to:
identify an enable signal from the source surface pipe programming; and
identify the region of interest based at least in part on the enable signal, wherein selecting the region of interest is based at least in part on identifying the region of interest.

12. The apparatus of claim 11, wherein the first histogram is determined based at least in part on the enable signal.

13. The apparatus of claim 9, wherein the instructions are further executable by the processor to cause the apparatus to:
determine a second histogram that is based at least in part on gray level values of the display panel; and
modify the second histogram based at least in part on gray level values of a background region, wherein the first histogram is determined based at least in part on modifying the second histogram.

14. The apparatus of claim 13, wherein the instructions are further executable by the processor to cause the apparatus to:
identify a first number of pixels of the background region of the display;
identify one or more gray level values of the second histogram that correspond to the background region;
identify a second number of pixels corresponding to the one or more gray level values; and
subtract the first number of pixels from the second number of pixels for the one or more gray level values of the second histogram, wherein the second histogram is modified based at least in part on the subtracting.

15. The apparatus of claim 9, wherein the instructions are further executable by the processor to cause the apparatus to:
identify a video enable signal from the source surface pipe programming; and
identify a number of rows of the image and a number of columns of the image based at least in part on identifying the video enable signal, wherein the region of interest is selected based at least in part on the number of rows and the number of columns.

16. The apparatus of claim 15, wherein the instructions to adjust the one or more gray levels of the region of interest are executable by the processor to cause the apparatus to:
perform an adaptive backlight adjustment process on the region of interest based at least in part on the video enable signal and the first histogram.

17. An apparatus for adjusting a display at a device, comprising:
means for identifying an image based at least in part on source surface pipe programming;
means for selecting a region of interest that is a subset of a display panel that comprises the image based at least in part on the source surface pipe programming;
means for determining a first histogram that is based at least in part on gray level values of the region of interest; and
means for adjusting one or more gray levels of the region of interest based at least in part on the first histogram.

18. The apparatus of claim 17, further comprising:
means for identifying a number of pixels of a background region of the display and a gray level value that corresponds to the background region based at least in part on the source surface pipe programming, wherein the first histogram is determined based at least in part on the number of pixels and the gray level value.

19. The apparatus of claim 17, further comprising:
means for identifying an enable signal from the source surface pipe programming; and
means for identifying the region of interest based at least in part on the enable signal, wherein selecting the region of interest is based at least in part on identifying the region of interest.

20. The apparatus of claim 19, wherein the first histogram is determined based at least in part on the enable signal.
